(19) United States
(12) Patent Application Publication
(10) Pub. No.: US 2012/0330828 A1
(43) Pub. Date: Dec. 27, 2012

(54) MECHANISM FOR FRAUD-RESISTANT CONSUMER TRANSACTIONS

(76) Inventor: C. Andrew Neff, Bellevue, WA (US)

(21) Appl. No.: 13/483,180

(22) Filed: May 30, 2012

Related U.S. Application Data
(63) Continuation of application No. 13/111,359, filed on May 19, 2011, now abandoned.
Application No. 13/111,359 is a continuation of application No. 11/863,075, filed on Sep. 27, 2007, now abandoned.
(60) Provisional application No. 60/848,570, filed on Sep. 27, 2006.

(51) Int. Cl. G06Q 20/14

(52) U.S. Cl. 705/40

(57) ABSTRACT

A facility for conducting a financial transaction is described. The facility receives a purchase order identifying a customer and an amount of a payment to be made by the identified customer to a payee. The customer identified by the purchase order has an individual account. The facility selects an account from a pool of accounts designated as being shared by a number of customers including the identified customer. The shared pool does not include the identified customer's individual account. The facility transfers the identified amount from the identified customer's individual account to the selected account of the shared pool. The facility causes information identifying a credit card number for the selected account of the shared pool to be provided to the payee for use in effecting the payment.

### CROSS-REFERENCE TO RELATED APPLICATIONS

This application is a continuation of U.S. patent application Ser. No. 13/111,359, filed May 19, 2011, which is a continuation of U.S. patent application Ser. No. 11/863,075, filed Sep. 27, 2007, which claims the benefit of U.S. Provisional Application No. 60/848,570, filed Sep. 27, 2006, each of which is hereby incorporated by reference in its entirety.

### TECHNICAL FIELD

The described technology is directed to the field of technology supporting financial transactions, and, more particularly, to the field of technology supporting secure financial transactions.

### BACKGROUND

The card numbers used by Customers in consumer credit and debit transactions today are vulnerable to fraud and misuse largely because they are static identifiers. That is, the same identifier that is used in a first transaction can immediately be used again in subsequent transactions not authorized by the Customer. Interception of the credit/debit number is not a concern now, since SSL, which is almost universally used, maintains a private communication channel between Customer and Merchant. However, by submitting the card number at all, the Customer gives up control of it to the Merchant—at least in principle. Dishonest merchants can abuse this control. More commonly, the Merchant accidentally reveals (i.e., loses) the card data to a dishonest intruder, or to a dishonest employee.

Card Organizations (VISA, MasterCard, etc.) and their participating Financial Institutions have tried to counter this vulnerability by demanding more identifying information (e.g., ‘name’, ‘address’, ‘CCV’, etc.) from the Customer as part of each transaction in order to authorize payment. However, all of these pieces of information are themselves only static identifiers. At best their use only delays exposure to the very same fraud vulnerability, i.e., abuse by dishonest or insecure Merchants. In fact, requiring that customer to provide additional identifying information to the merchant may give rise to greater risk to identity theft or other forms of fraud enabled by this identifying information in the case of a dishonest or insecure merchant.

Information security techniques that address this threat much more robustly do exist. These techniques (e.g., digital signatures, one time use hardware tokens, etc.) achieve a much higher level of fraud protection by using a unique identifier for each transaction which can be generated only by the proper individual. Unfortunately, it has been difficult to introduce them to the general population because of the huge legacy effect imposed by the existing credit and debit card systems, as well as a reluctance by Customers to adopt less convenient processes, even when more secure.

### BRIEF DESCRIPTION OF THE DRAWINGS

FIG. 1 is a block diagram showing some of the components typically incorporated in at least some of the computer systems and other devices on which the facility executes.

FIGS. 2-5 are data flow diagrams showing interactions performed in accordance with the technique.

FIG. 6 is a flow diagram showing steps typically performed by the facility in order to perform a system initialization process.

FIG. 7 is a flow diagram showing steps typically performed by the facility in order to complete a customer registration process.

FIG. 8 is a flow diagram showing steps typically performed by the facility in order to conduct a secure online payment.

### DETAILED DESCRIPTION

A software facility for supporting fraud-resistant consumer transactions (“the facility”) is provided that uses a shared, recirculating pool of “pay-through accounts” as the basis for individual consumer charges. When a customer has placed an order with a web merchant and is ready to make an online payment to pay for the order, an invoice reflecting the amount of the payment to be made is signed using a private key of the customer and submitted to a payment translation service. After verifying that the signature is valid, the payment translation service selects a pay-through account from a pool of pay-through accounts that are shared across a number of different customers, such as all of the customers having an account at the same financial institution as the customer in question. Because each pay-through account in the pool can be used to make payments on behalf of different customers at different times, the pay-through accounts in the pool are sometimes referred to as “recirculating.” The payment translation service then transfers the amount of the payment from the customer's account at the financial institution to the selected pay-through account, and returns information identifying a credit or debit card number associated with the selected pay-through account to the customer. This information is then submitted to the merchant, which uses it to submit and settle a charge against the selected pay-through account. This approach has the advantage that it uses standard, existing banking mechanisms and procedures, without the need to recognize charge transactions as corresponding to one-time use credit card numbers, or do any special processing for them. Ultimately, by standard settlement processes, the amount transferred from the customer's account to the selected pay-through account is transferred to the merchant.

In various embodiments, the facility provides a number of different approaches to exchanging any necessary data. These include having the customer cut and paste information between a first browser window corresponding to a browsing session with the merchant in the second browsing window corresponding to a browsing session with the payment translation service; a customized browser, or browser plug-in that automatically handles all necessary exchange of information; a shopping portal hosted by the payment translation service or financial institution, through which the customer does all of his or her shopping, and which intercepts exchanges between the customer's browser and the merchant's server as necessary to implement the facility; and augmentation of merchants' web sites to direct the customer to interact with the payment translation service in a way that results in payment information for the pay-through account being provided by the payment translation service to the merchant.

By providing this payment translation service in some or all of the ways described above, the facility provides additional security to consumer transactions without imposing a significant burden on customers, without requiring any changes to the existing credit card and debit card charge settlement processes and mechanisms, and requiring few or no changes to the websites provided by and the processes performed by merchants.

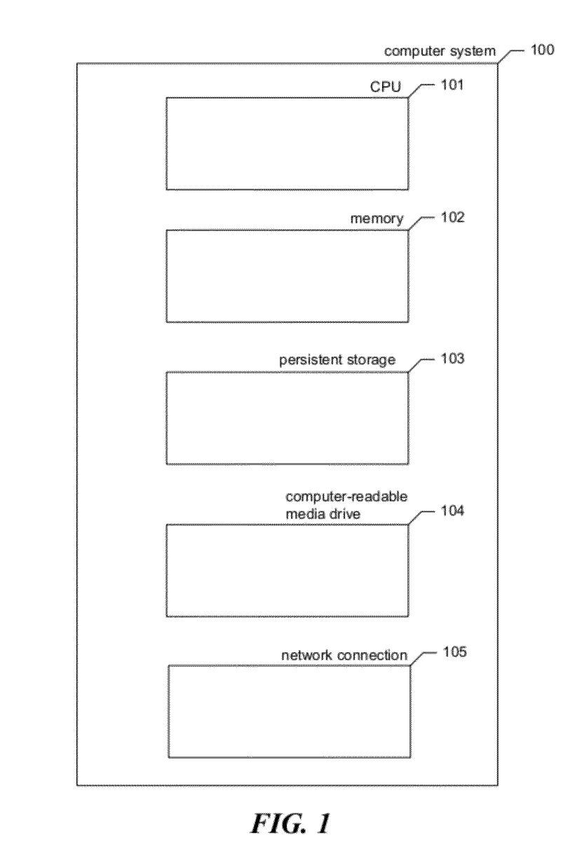

FIG. 1 is a block diagram showing some of the components typically incorporated in at least some of the computer systems and other devices on which the facility executes. These computer systems and devices 100 may include one or more central processing units (“CPUs”) 101 for executing computer programs; a computer memory 102 for storing programs and data—including data structures, database tables, other data tables, etc.—while they are being used; a persistent storage device 103, such as a hard drive, for persistently storing programs and data; a computer-readable media drive 104, such as a CD-ROM drive, for reading programs and data stored on a computer-readable medium; and a network connection 105 for connecting the computer system to other computer systems, such as via the Internet, to exchange programs and/or data—including data structures. In various embodiments, the facility can be accessed by any suitable user interface including Web services calls to suitable APIs. While computer systems configured as described above are typically used to support the operation of the facility, one of ordinary skill in the art will appreciate that the facility may be implemented using devices of various types and configurations, and having various components, such as wireless telephones and similar devices.

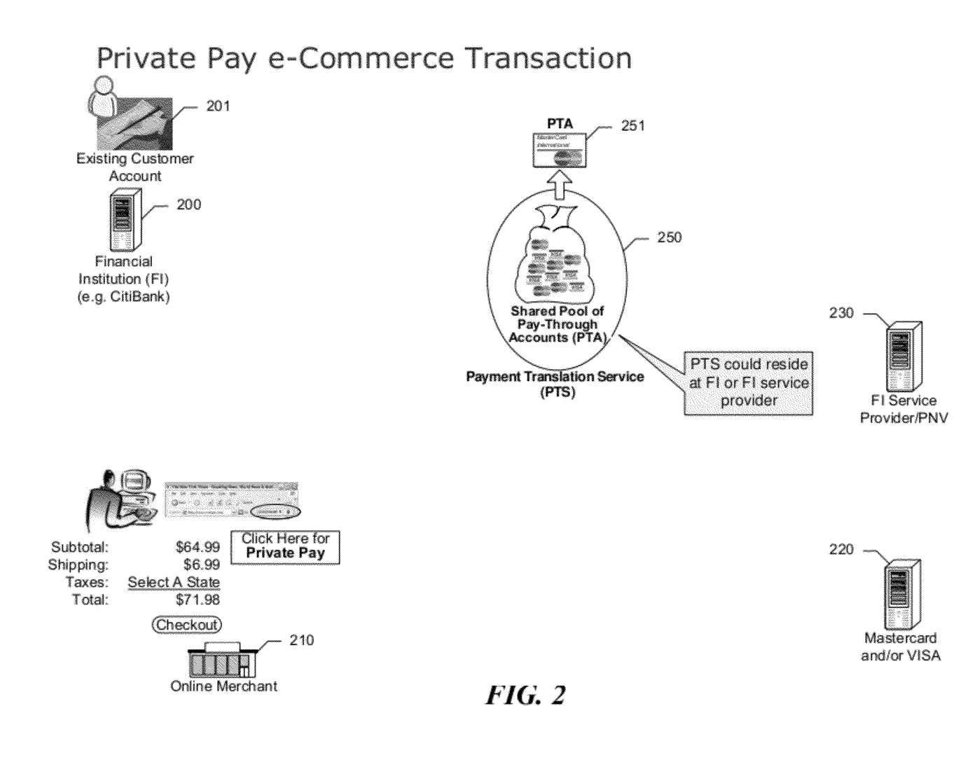

FIGS. 2-5 are data flow diagrams showing interactions performed in accordance with the technique. FIG. 2 shows a financial institution computer system 200 and a customer account 201. It shows an online merchant 210 from which the customer may make a purchase. It shows a card organization computer system 220 with which the online merchant computer system interacts to settle a charge transaction, and a financial institution service provider/PNV computer system 230. It shows a payment translation service 250 that establishes a shared pool of pay-through accounts 251.

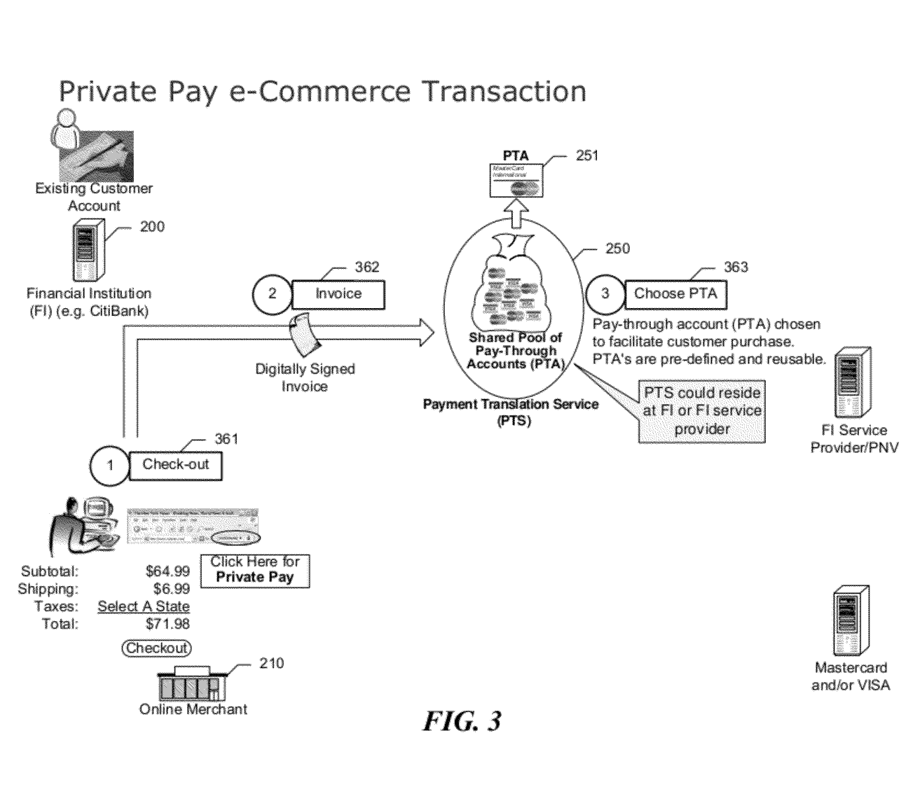

FIG. 3 shows the customer performing a check-out process 361 at the merchant to conclude a purchase. The customer's browser transmits a digitally-signed invoice 362 to the payment translation service 250. In response, after verifying that the invoice was properly signed by the customer, the payment translation service chooses a particular pay-through account to use for the transaction.

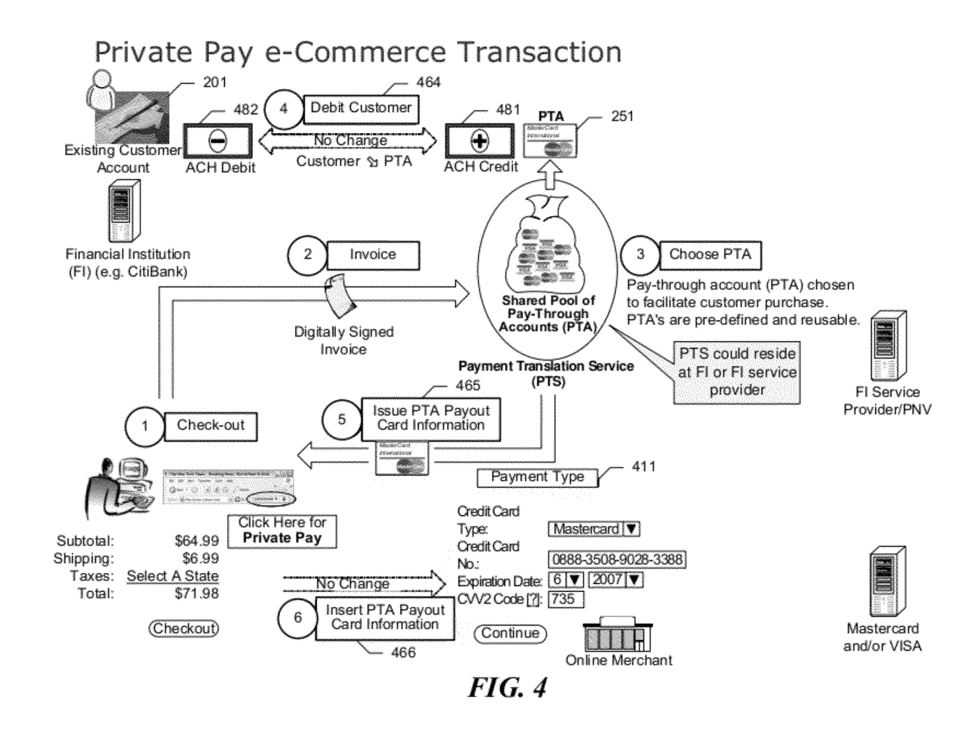

FIG. 4 shows the payment translation service performing a debit customer process 464, in which the existing customer account 201 is debited 482 and the selected pay-through account 251 is credited 481, both by the amount indicated by the invoice. The payment translation service then transmits payment card information 465 associated with the selected pay-through account—such as a credit card or debit card number associated with the selected pay-through account—to the merchant and/or to the customer's computer system. This information for the pay-through account credit card number is inserted 466 into the merchant's check-out form.

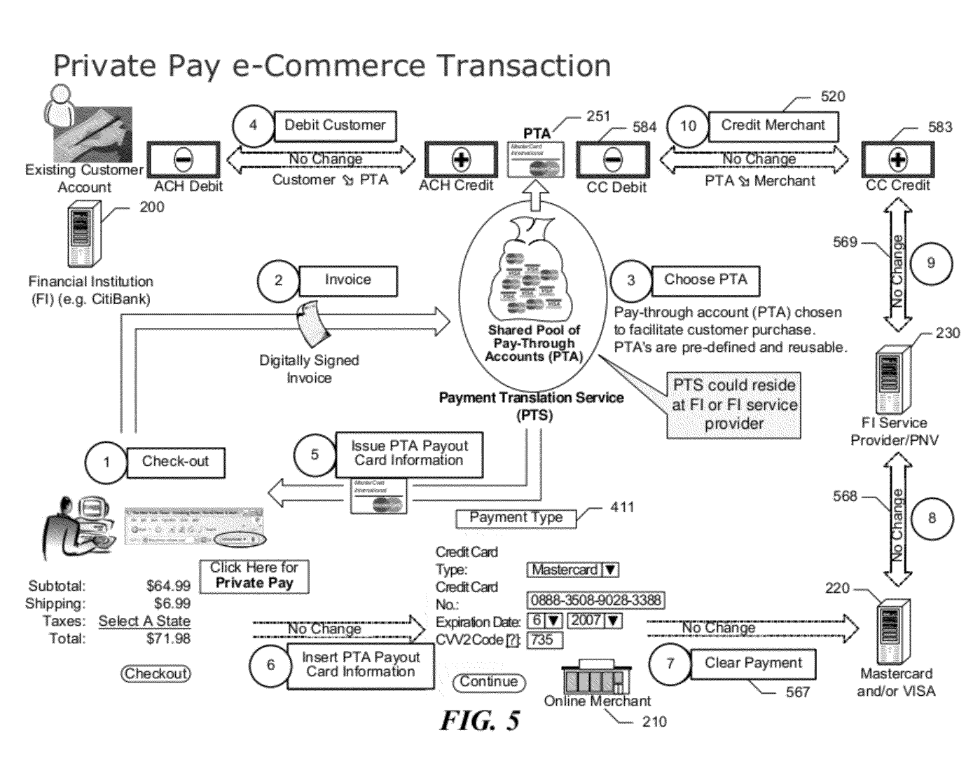

FIG. 5 shows the merchant submitting a charge against the pay-through account payment card in a conventional matter to a charge-settlement process, in which the charge is settled in a conventional matter. In particular, the merchant sends the charge 567 to the card organization computer system 220. The card organization computer system 220 sends the charge 568 to the financial institution service provider computer system 230. The financial institution service provider computer system 230 sends the charge 569 to the financial institution computer system 200, which causes the merchant's account to be credited for the amount of the charge, and the selected pay-through account to be debited for the amount of the charge.

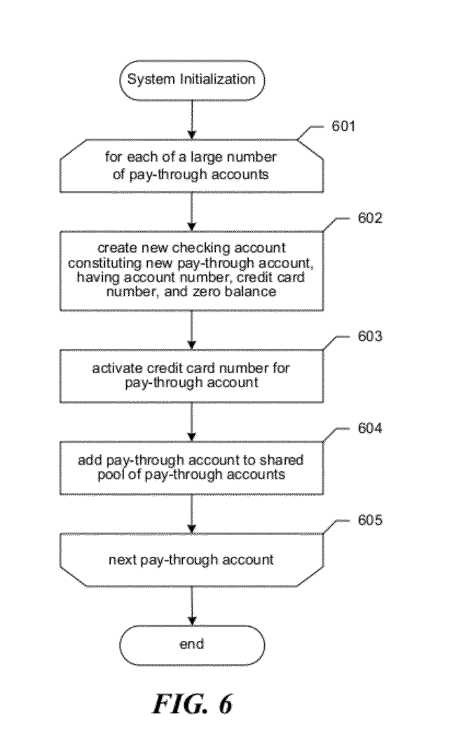

FIGS. 6-8 are flow diagrams showing sample implementations of processes performed by the facility. FIG. 6 is a flow diagram showing steps typically performed by the facility in order to perform a system initialization process. The facility typically performs these steps once to initialize operations for a particular financial institution. In steps 601-605, the facility loops through each of a large number of pay-through accounts to populate a pool of pay-through accounts that is shared across the customers having accounts with the financial institution, such as 1,000 pay-through accounts, or 10,000, or 100,000. In step 602, the facility creates a new checking account constituting a new pay-through account. The created checking account has an account number, a credit card number, and a zero balance. In some embodiments, the created checking account has a debit card number rather than a credit card number. In some embodiments, accounts of types other than checking accounts, such as savings accounts, are created to serve as pay-through accounts.

In step 603, the facility activates the credit card number for the pay-through account created in step 602. In step 604, the facility adds to the pay-through account created in step 602 to the shared pool of pay-through accounts. In step 605, if additional pay-through accounts remain to be created, then the facility continues in step 601 to create the next one, else these steps conclude.

Those skilled in the art will appreciate that the steps shown in FIG. 6 and in each of the flow diagrams discussed below may be altered in a variety of ways. For example, the order of the steps may be rearranged; substeps may be performed in parallel; shown steps may be omitted, or other steps may be included; etc.

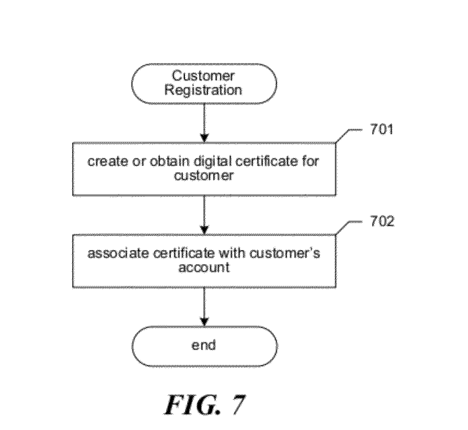

FIG. 7 is a flow diagram showing steps typically performed by the facility in order to complete a customer registration process. The facility typically performs the customer registration process for each customer of the financial institution for whom payment translation is enabled. In step 701, the facility obtains a digital certificate associated with the customer that can be used to verify signatures made by the customer with a private key possessed by the customer and corresponding to the digital certificate. In some cases, the private key and digital certificate are created for the customer by or on behalf of the facility. In step 702, the facility associates the certificate with the customer's account with the financial institution, such as by storing the certificate in a row of a table corresponding to the customer's account. After step 702, these steps conclude, and the customer can proceed to make online payments using the facility. In some embodiments, the facility associates authorization credentials other than a digital certificate with the customer, such as a password used by the customer, an image feature used to authenticate the user, biometric attributes used to authenticate the user, details of the challenge-response mechanism, details of a time-based access generator, etc. Where the authentication credentials already associated with the customer's account, such as where a password used by the customer to access the financial institution's online banking website is already associated with the customer's account, then the steps of FIG. 7 are unnecessary and can be omitted by the facility.

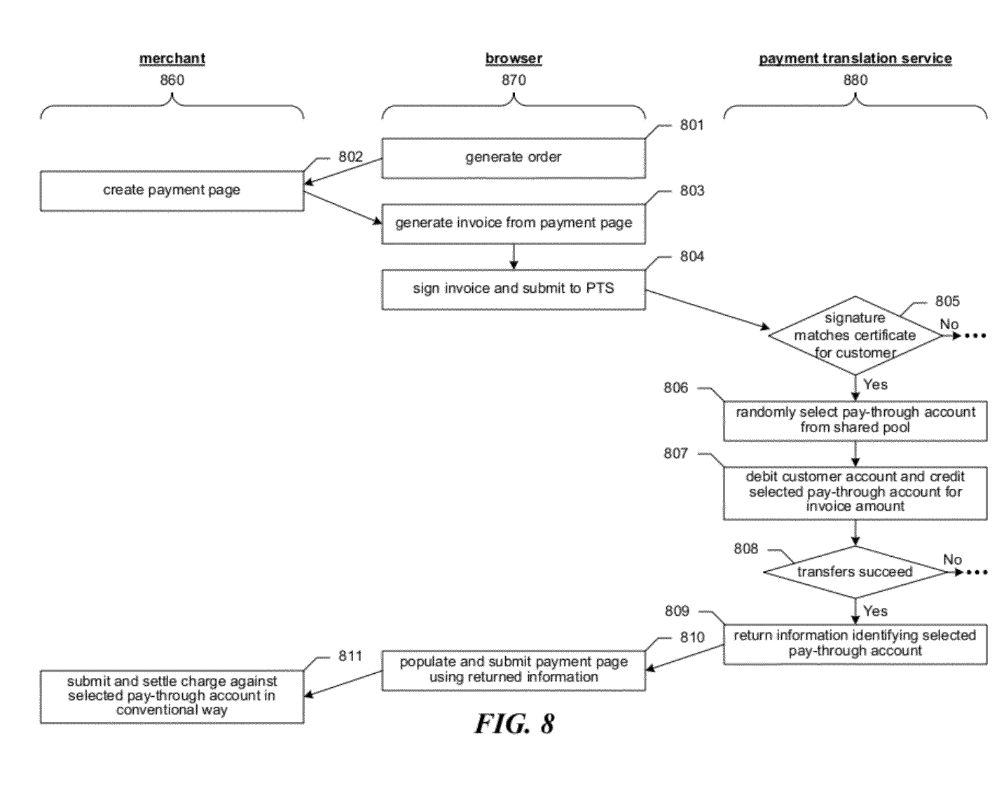

FIG. 8 is a flow diagram showing steps typically performed by the facility in order to conduct a secure online payment. The flow diagram is organized into three columns: a column 860 containing steps performed by a merchant's server, a column 870 containing steps performed by the customer's browser, and a column 880 containing steps performed by the payment translation service. As will be discussed below in greater detail, some of these steps can be performed in ways different than those shown, and/or by different computer systems.

In step 801, the customer's browser generates an order by interacting with the merchant's website. In response, in step 802, the merchant's server creates a payment page—i.e., Checkout page—that includes both a total amount due from the customer and fields for providing payment information identifying a credit card to pay that amount. In step 803, the browser uses information from the payment page received from the merchant to generate an invoice, which contains at least the amount due from the payment page. In step 804, the browser signs the invoice using the customer's private key, and submits the signed invoice to the payment translation service, along with information identifying the customer, such as the customer's account number.

In step 805, if the payment translation service is able to verify the signature on the invoice it receives from the customer's browser against the certificate for the customer, then the facility continues in step 806, else this process terminates. In step 806, the payment translation service selects a pay-through account from the shared pool of pay-through accounts. In some embodiments, the selection of step 806 is random. In some embodiments, the facility bases this selection on such factors as the balances of the pay-through accounts, and/or the times at which the pay-through accounts were last selected for use in a transaction. In some embodiments, only pay-through accounts whose balances are zero are eligible for selection.

In step 807, the payment translation service debits the customer's account and credits the pay-through account selected in step 806, both for the amount due shown by the invoice. In some embodiments, the debited customer account is a depositary account of the customer's, such as a checking, savings, or brokerage account. In some embodiments, the debited customer account is a credit or charge account or other line of credit. In some embodiments, the facility uses ACH transfers to effect the debit and credit options of step 807. In step 808, if both the debit and credit operations of step 807 succeed, then the facility continues in step 809, else any succeeding debit or credit operation is reversed and this process terminates. In step 809, the payment translation service returns information identifying the pay-through account selected in step 806 to the customer's browser. Such information may include, for example, a credit card number, expiration date, CCV, account holder name, billing address, etc. In some embodiments, the payment translation service further stores a record of the transaction, identifying at least the customer account, the pay-through account, and the amount, to facilitate later reversal of the transaction if this turns out to be necessary.

In step 810, the customer's browser populates and submits the payment page created by the merchant in step 802 using the information returned by the payment translation service in step 809. In step 811, when the merchant's server receives the submitted payment page, the merchant uses standard, conventional techniques to submit and settle a charge for the amount due against the pay-through account selected in step 806. This entire submission and settlement process can be performed by all of the involved systems without any understanding about the nature of the pay-through account or special-case processing therefor. These steps then conclude.

In some embodiments (not shown), when the pending charge or charges are settled against a pay-through account—i.e., its balance returns to zero—as part of returning the pay-through account to the pool for re-use, the facility performs a verification information reset process. This process involves altering some or all of the verification information associated with the pay-through account, such as expiration date, CCV, cardholder name, billing address, etc. By performing such alterations, the facility further reduces any opportunity for fraudulent re-use of pay-through accounts.

In various embodiments, the facility uses a variety of techniques to manage communications between the customer, the merchant, and the payment translation service. These include, but are not limited to, the following:

Customer Cut-and-Paste

The two communication channels, (1) between Customer and Merchant, and (2) between Customer and FI are implemented as two distinct web browser “windows,” or “tabs.” The Customer submits to the Merchant the payment chit information she received from the PTS via “cut-and-paste”—a feature already available in all major browsers.

This approach has the advantage that there is no need for client software that lies outside of standard web browser functionality. All new functionality is embodied in PTS web pages so that deployment is trivial. No Merchant participation is required.

Shopping Portal, Hosted by the FI or PTS

Customers shop at Merchant sites via a web “connection” that goes “through” the Customer's FI, or trusted representative of the FI. During the most of the shopping experience, the intermediate FI server merely passes data to and from Customer and Merchant. Only at point of “checkout” does the FI server modify the data stream. It does so by automating the “cut-and-paste” operation in that variation. In some embodiments, Customers authenticate themselves at the beginning of the shopping session, so that per-transaction authentication may be redundant, and hence is eliminated in some embodiments.

In various embodiments, the intermediate FI connection is enabled by one of two mechanisms:

1. Customers are encouraged to do their online shopping safely by starting at a site such as http://safeshop.myFI.com.
2. Customer web browser is configured to use FI server as a proxy server via a transparent protocol such as SOCKS for all browser traffic.

This approach has all the advantages of customer cut-and-paste. Additionally, there is no impact on customer shopping experience, creating no disincentive for using the facility.

Special Purpose Client Browser Plug-in

A browser plug-in approach, similar to the mechanism by which Macromedia's nearly ubiquitous Flash player is integrated into browsers, can similarly avoid creating any adverse impact on customer shopping experience. In fact, the shopping experience my even be improved since the plug-in can automate much of the form filling required at checkout time. Also, the potential to steer Customers towards using the new payment methodology is good. Again, absolutely no Merchant participation is required.

The plug-in may either provide an explicit mechanism for the customer to invoke a secure payment, and/or may automatically recognize merchant Checkout pages and automatically invoke a secure payment in a response. As for the former, the plug-in may, for example, provide a toolbar button for invoking a secure payment. As to the latter, the plug-in can automatically recognize a Checkout page by examining the document object model (“DOM”) for each page retrieved and displayed by the browser, looking for such indicators of a Checkout page as fields having names such as “card number,” “CCV,” “billing address,” etc. The plug-in can also analyze content on each page other than field names, including text or image content, as well as top-level attributes for the page such as the protocol used to retrieve the page.

Adapted Browser

Any techniques implemented in a browser plug-in can instead or also be directly integrated into shipping versions of one or more browsers. A customer using such a browser would not need to download or install the browser plug-in described above.

Merchant Cooperation

Merchants “embed” the payment functionality in their Checkout pages. In particular, a merchant adds to its Checkout page a control, such as a button, that, when activated by the user, sends a request to the PTS server providing invoice data. The PTS server returns a web page that performs customer authentication, after which it assigns a pay-through account and returns a copy of the merchant's Checkout page with information about the selected pay-through account pre-populated. The user can then submit this copy of the merchant's Checkout page to the merchant by activating a submit control included in the page returned by the PTS server.

The technology to support this is partially illustrated by, for example, embedded YouTube videos. Examples of existing payment systems that require Merchant participation are PayPal and Google Checkout.

In some embodiments, rather than collecting customer authentication information in a webpage served by the PTS server, the merchant further adds a mechanism to its Checkout page that collects this authentication information from the user when the control is activated and forwards it to the PTS server. In some embodiments, this functionality is provided using a javascript window or other appropriate approaches.

This approach has the advantage that Customer shopping experience can be enhanced and behavior modifications encouraged without the need for a client plug-in. Additionally, much of the form parsing capability required of the software can be drastically simplified if not completely eliminated.

Those skilled in the art will appreciate that a variety of other mechanisms may be used to exchange the data used by the facility.

While the foregoing principally describes transaction authorization from the customer taking the form of a digital signature on an invoice or purchase order that is based upon information from the merchant, in various embodiments the facility employs a wide variety of other authorization mechanisms. For example, authorization made be performed using a customer password, such as a password already used by the customer to access the financial institution's online banking site; an image features selection authentication system; a challenge and response authentication system; a time-based access code generator; or a variety of other mechanisms.

It will be appreciated by those skilled in the art that the above-described facility may be straightforwardly adapted or extended in various ways. For example, the facility may be used with various kinds of financial institutions, merchants, and account types. While the foregoing description makes reference to particular embodiments, the scope of the invention is defined solely by the claims that follow and the elements explicitly recited therein.

1-25. (canceled)

26. A method in a computing system having a processor for conducting a financial transaction, comprising:
creating a pool of accounts;
creating an association associating the created pool of accounts with a plurality of customers who share the accounts of the pool;
activating a credit card number for each of the accounts of the shared pool;
receiving a purchase order identifying a customer among the plurality of customers and an amount of a payment to be made by the identified customer to a payee, the amount being equal to an amount earlier calculated by the payee to be due from the identified customer, the purchase order bearing a signature, the identified customer having an individual account not among the shared pool of accounts;
only if the signature can be verified to have been formed by the identified person:
with the processor, using the created association to select one of the accounts of the shared pool;
debiting the identified amount from the identified customer's individual account;
crediting the identified amount to the selected account of the shared pool; and
causing to be provided to the payee information identifying the credit card number activated for the selected account of the shared pool,
such that the payee may submit and settle a credit card charge for the identified amount against the identified credit card number, and ultimately against the selected account of the shared pool, without having to map the provided information identifying the credit card number to the identified customer's individual account.

27. A computer-readable storage medium whose contents are capable of causing a computing system to perform a method for conducting a financial transaction, the method comprising:
creating an association associating a pool of accounts with a plurality of customers who share the accounts of the pool;
receiving a purchase order identifying a customer among the plurality of customers and an amount of a payment to be made by the identified customer to a payee, the amount being equal to an amount earlier calculated by the payee to be due from the identified customer, the identified customer having an individual account;
in response to receiving the purchase order, using the created association to select an account from the pool of accounts, the pool not including the identified customer's individual account;
transferring the identified amount from the identified customer's individual account to the selected account of the pool; and
causing information identifying a credit card number for the selected account of the pool to be provided to the payee for use in effecting the payment.

28. The computer-readable storage medium of claim 27, the method further comprising, before the selecting, transferring, and causing, verifying that the identified customer has authorized the purchase order.

29. The computer-readable storage medium of claim 28 wherein the verifying comprises successfully verifying that a signature on the purchase order is consistent with a digital certificate associated with the identified customer.

30. The computer-readable storage medium of claim 28 wherein the verifying comprises determining that a password provided by the identified customer matches a password associated with the identified customer.

31. A method in a computing system having a processor for conducting a financial transaction, comprising:
receiving a purchase order identifying a customer and an amount of a payment to be made by the identified customer, the identified customer having an individual account;
in response to receiving the purchase order:
with the processor, selecting an account other than the identified customer's individual account, the information contained by the received purchase order not being determinative of the identity of the account that is selected;
transferring the identified amount from the identified customer's individual account to the selected account; and
transmitting information identifying a payment card of the selected account for use in effecting the payment.

32. The method of claim 31 wherein the information identifying a payment card comprises a credit card number.

33. The method of claim 31 wherein the information identifying a payment card comprises a debit card number.

34. The method of claim 31 wherein the information identifying the payment card comprises a payment card number associated with the selected account, together with verification information associated with the payment card number that is distinct from the payment card number.

35. The method of claim 34 wherein the verification information comprises a CCV.

36. The method of claim 34 wherein the verification information comprises at least a portion of a billing address.

37. The method of claim 34, further comprising:
determining that a charge transaction submitted by the payee against the selected account has been settled;
in response to the determining, altering the verification information associated with the payment card number;
subsequent to the altering, receiving a second purchase order identifying a second customer having an individual account and a second amount to be paid to a second payee; and
in response to receiving the second purchase order:
transferring the second identified amount from the identified second customer's individual account to the selected account of the pool, and
causing to be provided to the second payee the payment card number associated with the selected account of the pool, together with altered verification information associated with the payment card number.

38. The method of claim 31 wherein the information identifying a payment card for the selected account of the pool is provided to the payee by providing the information identifying a payment card for the selected account of the pool to the identified customer to enable the identified customer to manually paste the identifying information into one or more fields of a form posted to a web server operating on behalf of the payee.

39. The method of claim 31 wherein a proxy server provides to the payee the information identifying a payment card for the selected account of the pool by automatically injecting the identifying information into a browser session between the identified customer and a web server operating on behalf of the payee.

40. The method of claim 31 wherein the information identifying a payment card for the selected account of the pool is provided to the payee by automatically prefilling the identifying information into one or more fields of a form which is then posted to a web server operating on behalf of the payee,
and wherein the automatic prefilling is performed by a component integrated into a browser used by the customer, wherein the integration is performed by an extensibility mechanism provided in connection with the browser.

41. The method of claim 40 wherein the extensibility mechanism is a browser plug-in.

42. The method of claim 40 wherein the extensibility mechanism is a browser toolbar.

43. The method of claim 31 wherein the information identifying a payment card for the selected account of the pool is provided to the payee by automatically prefilling the identifying information into one or more fields of a form which is then posted to a web server operating on behalf of the payee,
and wherein the automatic prefilling is performed by functionality included in a version of a browser shipped by the browser's lender.

44. The method of claim 31 wherein the information identifying a payment card for the selected account of the pool is provided to the payee by automatically prefilling the identifying information into one or more fields of a form which is then posted to a web server operating on behalf of the payee,
and wherein the automatic prefilling is performed before the form is served to a browser used by the customer.

45. One or more instances of computer-readable storage media collectively storing a payment information data structure corresponding to a payment for a distinguished amount on behalf of a distinguished customer having an account for exclusive use of the distinguished customer, comprising:
a credit card number having a one-to-one relationship with a distinguished one of a pool of accounts shared across a plurality of customers including the distinguished customer, the distinguished shared account having been randomly selected from shared accounts among the pool of shared accounts without regard for the specific identity of the distinguished customer at a time after the distinguished amount was determined by a merchant as being due from the distinguished customer, the distinguished amount having been transferred from the distinguished customer's account to the distinguished shared account at a time after the distinguished amount was determined by a merchant as being due from the distinguished customer; and
at least one piece of confirmatory information associated with the credit card number,
such that the contents of the data structure may be submitted by the merchant to a credit card charge clearance network to obtain payment of the distinguished amount.

46. The instances of computer-readable storage media of claim 45 wherein the hardware devices comprise a computer memory that stores the payment information data structure.

47. The instances of computer-readable storage media of claim 45 wherein the hardware devices comprise a data transmission network that conveys the payment information data structure.

48. The instances of computer-readable storage media of claim 45 wherein the confirmatory information comprises a cardholder name associated with the credit card number that does not match the distinguished customer's name.

49. The instances of computer-readable storage media of claim 45 wherein the confirmatory information comprises a billing address associated with the credit card number at which the distinguished customer does not receive mail.

50. A method in a computing system having a processor for conducting financial transactions, comprising:
receiving a purchase order identifying a first customer and an amount of a first payment to be made by the first customer to a first payee, the first customer having an individual account;
transferring the amount of the first payment from the first customer's individual account to a distinguished pay-through account;
with the processor, causing information identifying a payment card number for the distinguished pay-through account to be provided to the first payee for use in effecting the first payment;
receiving a purchase order identifying a second customer and an amount of a second payment to be made by the second customer to a second payee, the second customer having an individual account;
transferring the identified amount of the second payment from the second customer's individual account to the distinguished pay-through account; and
with the processor, causing information identifying a payment card number for the distinguished pay-through account to be provided to the second payee for use in effecting the second payment.

51. The method of claim 26, further comprising:
settling a credit card charge for the identified amount against the identified credit card number, and ultimately against the selected account of the pool; and
in response to an indication to reverse the settled credit card charge, automatically transferring the amount to the identified customer's individual account.

52. The method of claim 26 wherein the receiving, verifying, selecting, debiting, crediting, and causing are performed by a provider of an explicitly-identified secure payment service, and wherein the selecting, debiting, crediting, and causing are performed automatically in response to the receiving and verifying.

53. The computer-readable storage medium of claim 27, the method further comprising:
settling a credit card charge for the identified amount against the identified credit card number, and ultimately against the selected account of the pool; and
in response to an indication to reverse the settled credit card charge, automatically transferring the amount to the identified customer's individual account.

54. The computer-readable storage medium of claim 27 wherein the receiving, selecting, transferring, and causing are performed by a provider of an explicitly-identified secure payment service, and wherein the selecting, transferring, and causing are performed automatically in response to the receiving.

55. The method of claim 31, further comprising:
settling a credit card charge for the identified amount against the identified credit card number, and ultimately against the selected account; and
in response to an indication to reverse the settled credit card charge, automatically transferring the amount to the identified customer's individual account.

56. The method of claim 31 wherein the receiving, selecting, transferring, and causing are performed by a provider of an explicitly-identified secure payment service, and wherein the selecting, transferring, and causing are performed automatically in response to the receiving.

57. The method of claim 50 wherein the amount of the first payment is transferred from the first customer's individual account to the distinguished pay-through account at a time after the amount of the first payment was determined by the first payee as being due from the first customer,
and wherein the amount of the second payment is transferred from the second customer's individual account to the distinguished pay-through account at a time after the amount of the second payment was determined by the second payee as being due from the second customer.

58. The method of claim 50, further comprising:
settling a credit card charge for the amount of the first payment against the payment card number for the distinguished pay-through account, and ultimately against distinguished pay-through account; and
in response to an indication to reverse the settled credit card charge, automatically transferring the first amount to the first customer's individual account.

59. The method of claim 50 wherein the receiving, transferring, and causing are performed by a provider of an explicitly-identified secure payment service, and wherein the transferring and causing are performed automatically in response to the receiving.

60. A computer-readable storage medium whose contents are capable of causing a computing system to perform a method for calculating financial transactions, the method comprising:
receiving a purchase order identifying a first customer and an amount of a first payment to be made by the first customer to a first payee, the first customer having an individual account;
transferring the amount of the first payment from the first customer's individual account to a distinguished pay-through account;
causing information identifying a payment card number for the distinguished pay-through account to be provided to the first payee for use in effecting the first payment;
receiving a purchase order identifying a second customer and an amount of a second payment to be made by the second customer to a second payee, the second customer having an individual account;
transferring the identified amount of the second payment from the second customer's individual account to the distinguished pay-through account; and
causing information identifying a payment card number for the distinguished pay-through account to be provided to the second payee for use in effecting the second payment.

61. The computer-readable storage medium of claim 60 wherein the amount of the first payment is transferred from the first customer's individual account to the distinguished pay-through account at a time after the amount of the first payment was determined by the first payee as being due from the first customer,
and wherein the amount of the second payment is transferred from the second customer's individual account to the distinguished pay-through account at a time after the amount of the second payment was determined by the second payee as being due from the second customer.

62. The computer-readable storage medium of claim 60, the method further comprising:
settling a credit card charge for the amount of the first payment against the payment card number for the distinguished pay-through account, and ultimately against distinguished pay-through account; and
in response to an indication to reverse the settled credit card charge, automatically transferring the first amount to the first customer's individual account.

63. The computer-readable storage medium of claim 60 wherein the receiving, transferring, and causing are performed by a provider of an explicitly-identified secure payment service, and wherein the transferring and causing are performed automatically in response to the receiving.

64. The method of claim 26, further comprising:
receiving a second purchase order identifying a second customer among the plurality of customers and a second amount of a payment to be made by the identified second customer to a second payee, the identified second customer having an individual account not among the shared pool of accounts;
debiting the identified second amount from the identified second customer's individual account;
crediting the identified second amount to the selected account of the shared pool; and
causing to be provided to the second payee information identifying a credit card number activated for the selected account of the shared pool.

65. The computer-readable storage medium of claim 27, the method further comprising:
receiving a second purchase order identifying a second customer among the plurality of customers and a second amount of a payment to be made by the identified second customer to a second payee, the identified second customer having an individual account;
using the created association to again select the originally-selected account from the pool of accounts;
transferring the identified second amount from the identified second customer's individual account to the selected account of the pool; and
causing information identifying the credit card number for the selected account of the pool to be provided to the second payee for use in affecting the payment.

66. The method of claim 31, further comprising:
receiving a purchase order identifying a second customer and a second amount of a payment to be made by the identified second customer, the identified customer having an individual account;
selecting the same account as was originally selected;
transferring the identified second amount from the identified second customer's individual account to the selected account; and
transmitting information identifying the payment card of the selected account for use in affecting the payment.

67. The method of claim 31 wherein the transmission of the payment card number returns the payment card number to the identified customer.

68. The method of claim 31 wherein the received purchase order includes information identifying a payee to which the identified amount is to be paid,
and wherein transmission of the payment card number is to the identified payee on behalf of the identified customer.

69. The method of claim 27 wherein the customer is unable to control which of the accounts of the pool is selected.
